(19) United States
(12) Patent Application Publication
(10) Pub. No.: US 2016/0138463 A1
(43) Pub. Date: May 19, 2016

(54) SYSTEM AND METHOD FOR PROVIDING MULTIPLE VOLTAGE BUSES ON A SINGLE VEHICLE

(71) Applicant: Arnold Magnetic Technologies, Rochester, NY (US)

(72) Inventor: Larry A. Kubes, Indianapolis, IN (US)

(21) Appl. No.: 14/542,953

(22) Filed: Nov. 17, 2014

(51) Int. Cl. F02B 37/10; B60R 16/03; H02K 7/18; F02B 37/00; F02B 63/04

(52) U.S. Cl. CPC F02B 37/10; F02B 37/004; F02B 63/042; H02K 7/1823; B60R 16/0307

(57) ABSTRACT

A system provides multiple voltage buses on a single vehicle having a combustion engine. The system includes at least one turbine disposed in flow communication with an exhaust flow of the combustion engine productive of exhaust gases; at least one generator operably connected to a respective one of the at least one turbine to produce respective AC electrical power in response to operation of the at least one turbine; a first inverter operably connected to the at least one generator to produce first electrical power in response to a presence of the respective AC electrical power; and a second inverter operably connected to the at least one generator to produce second electrical power in response to a presence of the respective AC electrical power. The first electrical power and the second electrical power have different voltages.

### BACKGROUND OF THE INVENTION

The present disclosure relates generally to a turbocharging system for an automotive system, more particularly to a turbocharging system employing an eTurbine, an eCompressor, or both and eTurbine and an eCompressor, and even more particularly to a turbocharging system configured for providing multiple voltage buses on a single vehicle.

With the increasing need to improve automotive tailpipe exhaust emissions, it is becoming increasingly important to be able to further enhance the efficiency of the combustion cycle, or use combustion cycle engines in combination with electric motor drive systems in a hybrid vehicle. Turbochargers do an exemplary job of increasing the intake air charge pressure, which forces more air into the combustion chamber to increase power output. A benefit of this increase in power output is that a relatively smaller engine can now be used to achieve the same vehicle drivability and performance. Additional benefits result from this engine downsizing in that during idle conditions, such as at stoplights, a smaller engine burns less fuel than a larger engine, but still provides enough power to the vehicle to power accessories such as air conditioning compressors and power steering pumps at idle, while maintaining good vehicle performance.

Engine downsizing with turbocharging is becoming very commonplace in the automotive industry. Current state of the art turbochargers use a turbine mounted in the exhaust stream to capture exhaust flow inertia and heat energy to turn a shaft that is coupled to a compressor which drives more air into the engine combustion chamber.

New trends in automotive turbocharging involve using an electric motor mounted to the turbocharger unit or to the individual components of the turbine and the compressor. These components are known as eTurbos, eTurbine, and eCompressor, respectively. Advanced power electronics have enabled inverters to be manufactured that can drive an electric motor to a highly controllable state, including clockwise and counterclockwise directions, to generate electrical power or provide motive force with very precise speeds and very rapidly changeable speeds from 0 to over 100,000 revolutions per minute (rpm).

While existing eTurbos, eTurbines and eCompressors may be suitable for their intended purpose, the art relating to automotive turbocharging systems would be advanced with a turbocharging system that offers additional opportunities to control and reduce exhaust emissions in, and improve the overall efficiency of, a combustion engine.

This background information is provided to reveal information believed by the applicant to be of possible relevance to the invention. No admission is necessarily intended, nor should be construed, that any of the preceding information constitutes prior art against the invention.

### BRIEF DESCRIPTION OF THE INVENTION

An embodiment of the invention includes a system for providing multiple voltage buses on a single vehicle having a combustion engine. The system includes at least one turbine disposed in flow communication with an exhaust flow of the combustion engine productive of exhaust gases; at least one generator operably connected to a respective one of the at least one turbine to produce respective AC electrical power in response to operation of the at least one turbine; a first inverter operably connected to the at least one generator to produce first electrical power in response to a presence of the respective AC electrical power; and a second inverter operably connected to the at least one generator to produce second electrical power in response to a presence of the respective AC electrical power. The first electrical power and the second electrical power have different voltages.

Another embodiment of the invention includes a system for providing multiple voltage buses on a single vehicle having a combustion engine. The system includes a first turbine disposed in flow communication with a first portion of an exhaust flow of the combustion engine productive of exhaust gases; a second turbine disposed in flow communication with a second portion of the exhaust flow of the combustion engine, the second portion being different from the first portion; a first generator operably connected to the first turbine to produce first AC electrical power in response to operation of the first turbine; a second generator operably connected to the second turbine to produce second AC electrical power in response to operation of the second turbine; a first inverter operably connected to the first generator to produce first electrical power in response to a presence of the first AC electrical power; and a second inverter operably connected to the second generator to produce second electrical power in response to a presence of the second AC electrical power. The first electrical power and the second electrical power have different voltages.

Another embodiment of the invention includes a system for providing multiple voltage buses on a single vehicle having a combustion engine. The system includes a turbine disposed in flow communication with an exhaust flow of the combustion engine productive of exhaust gases; a generator operably connected to the turbine to produce AC electrical power in response to operation of the first turbine; a first inverter operably connected to the generator to produce first electrical power in response to a presence of the AC electrical power; a second inverter operably connected to the generator to produce second electrical power in response to a presence of the second AC electrical power; and a switch operably disposed to connect the generator to the first inverter when the switch is in a first state, and to connect the generator to the second inverter when the switch is in a second state. The first electrical power and the second electrical power have different voltages.

Another embodiment includes a system for providing multiple voltage buses on a single vehicle having a combustion engine. The system includes a turbine disposed in flow communication with an exhaust flow of the combustion engine productive of exhaust gases, a generator operably connected to the turbine to produce AC electrical power in response to operation of the turbine, an inverter operably connected to the generator to produce first electrical power at a first voltage and second electrical power at a second voltage in response to a presence of the AC electrical power, the second voltage being different from the first voltage, and a switch operably disposed to connect the inverter to a first voltage bus when the switch is in a first state, and to connect the inverter to a second voltage bus when the switch is in a second state.

The above features and advantages and other features and advantages of the invention are readily apparent from the following detailed description of the invention when taken in connection with the accompanying drawings.

### BRIEF DESCRIPTION OF THE DRAWINGS

Referring to the exemplary non-limiting drawings wherein like elements are numbered alike in the accompanying Figures:

FIG. 1 depicts schematically an automotive system, in accordance with an embodiment of the invention;

FIG. 2 depicts schematically an alternative automotive system, in accordance with an embodiment of the invention; and

FIG. 3 depicts schematically another alternative automotive system, in accordance with an embodiment of the invention.

### DETAILED DESCRIPTION OF THE INVENTION

Although the following detailed description contains many specifics for the purposes of illustration, anyone of ordinary skill in the art will appreciate that many variations and alterations to the following details are within the scope of the invention. Accordingly, the following embodiments of the invention are set forth without any loss of generality to, and without imposing limitations upon, the claimed invention.

An embodiment of the invention, as shown and described by the various figures and accompanying text, provides a turbocharger system for a combustion engine that utilizes exhaust flow inertia and heat energy to drive at least one turbine, which in turn drives at least one generator for producing electrical power, which in turn is operably connected to first and second inverters to produce two different voltages on two different voltage buses. The two inverters may be operably connected to separate dedicated generators, or may be operably connected to a single generator via a switch.

While an embodiment is disclosed and described herein with reference to one or more inverters, it will be appreciated that each respective inverter may be bi-directional, or may not be bi-directional if it is used only to generate power. As such, one skilled in the art would appreciate that the disclosed and described inverters may be bi-directional or not depending on what purpose the disclosed system is to be used for as herein described.

As used herein, the term inverter or bi-directional inverter means a power electronic component or a bi-directional power electronic component, respectively, that is recognized in the art as being suitable for a purpose disclosed herein. For example, and as discussed further herein, an AC/DC converter may be used in some instances in place of an inverter.

While an embodiment described and illustrated herein depicts an inline four cylinder configuration as an exemplary combustion engine, it will be appreciated that the disclosed invention is not so limited and is also applicable to other cylinder configurations, such as but not limited to inline two cylinder, v-type two cylinder, inline three cylinder, inline five cylinder, inline six cylinder, v-type six cylinder, inline eight cylinder, v-type eight cylinder, inline ten cylinder, v-type ten cylinder, inline twelve cylinder, v-type twelve cylinder, and rotary engines having any number of combustion chambers, for example.

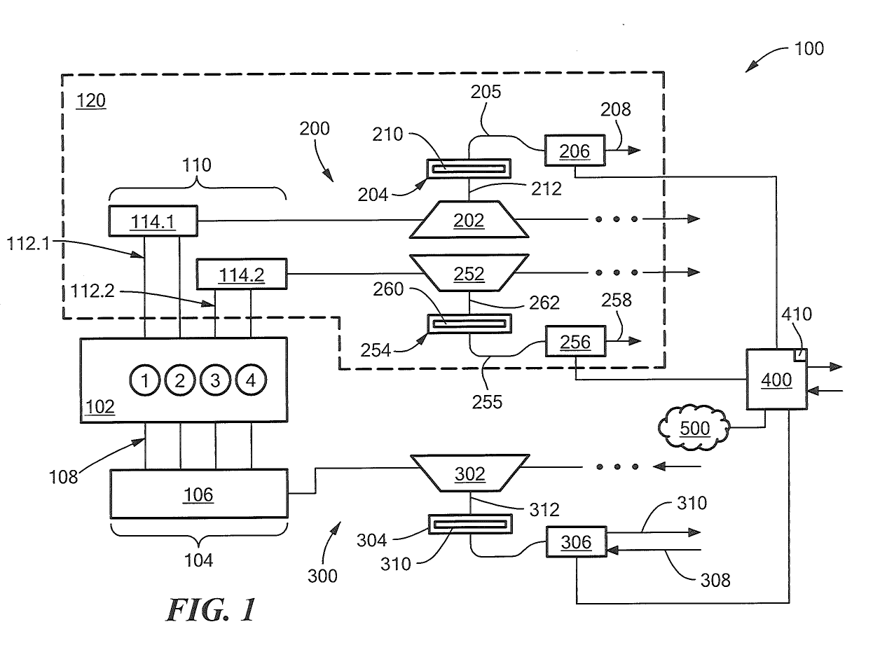

FIG. 1 depicts schematically an automotive system for a single vehicle 100 that includes a combustion engine (CE) 102, an eTurbine system 200, which will be discussed in more detail below, an eCompressor system 300, which will be discussed in more detail below, a vehicle control module (VCM) 400 operably connected to the eTurbine system 200 and the eCompressor system 300, and a controller area network (CAN) bus 500 disposed and configured in signal communication with and for operably communicating between the VCM 400 and other vehicle systems.

As used herein, the term vehicle is not limited to just an automobile, truck, van or sport utility vehicle, but includes any self-propelled, towed, or movable conveyance suitable for transporting or supporting a burden. While an embodiment is disclosed and described herein with reference to a vehicle 100, it will be appreciated that the vehicle 100 may alternatively be a stationary power system that operates in accordance with the disclosure provided herein. As such, the term “vehicle” is not intended to be limiting to the scope of the invention disclosed herein.

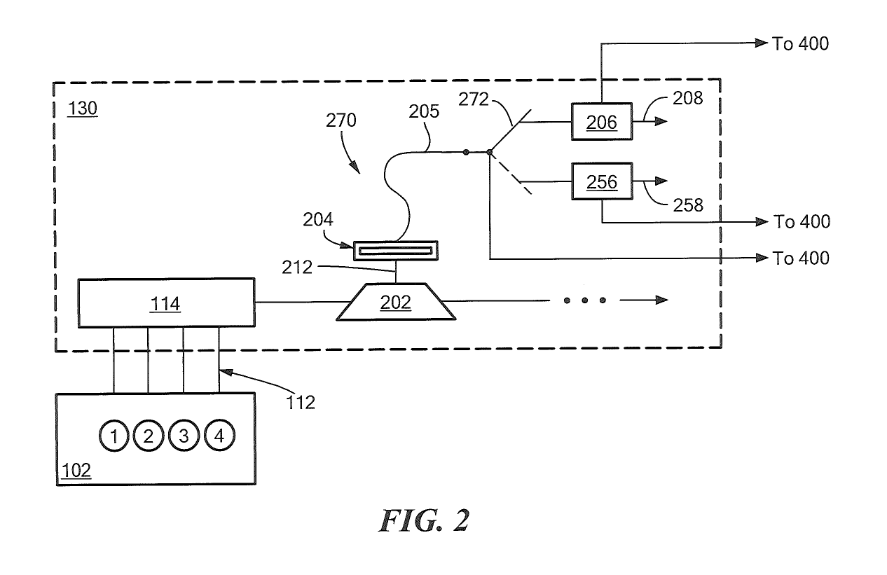

Disposed in flow communication with the CE 102 is an air intake system 104 that includes an intake manifold 106 and intake ports 108, and an exhaust output system 110 that includes first and second exhaust ports 112.1, 112.2, and first and second exhaust manifolds 114.1, 114.2. In an embodiment, and as depicted in FIG. 1, the first exhaust ports 112.1 and the first exhaust manifold 114.1 are disposed in flow communication with only a first portion of the exhaust flow produced by the CE 102, such as the left two cylinders 1, 2 for example, and the second exhaust ports 112.2 and the second exhaust manifold 114.2 are disposed in flow communication with only a second portion of the exhaust flow produced by the CE 102, such as the right two cylinders 3, 4 for example. In another embodiment, the exhaust manifolds 114.1, 114.2 may be combined (collectively referred to by reference numeral 114) and disposed in flow communication with the entire exhaust flow (best seen via exhaust ports 112 in FIG. 2) produced by the CE 102, which will be discussed in more detail below in connection with FIG. 2. While a certain arrangement is depicted herein for bifurcating the exhaust flow from the CE 102, it will be appreciated that such an arrangement is for illustration purposes only, and that other distributions of exhaust flow may be employed without detracting from the scope of the invention disclosed herein, which will be discussed in more detail below.

In an embodiment, and with reference still to FIG. 1, the eTurbine system 200 includes a first turbine 202 disposed in flow communication with the first exhaust manifold 114.1 that is in flow communication with the first exhaust ports 112.1 that communicate a first portion of exhaust flow of the CE 102 productive of exhaust gases, and a second turbine 252 disposed in flow communication with the exhaust manifold 114.2 that is in flow communication with the second exhaust ports 112.2 that communicate a second portion of the exhaust flow of the CE 102, where the second portion of the exhaust flow is different and isolated from the first portion of the exhaust flow. A first generator 204 is operably connected to the first turbine 202 to produce first AC electrical power on voltage line 205 in response to operation of the first turbine 202. A second generator 254 is operably connected to the second turbine 252 to produce second AC electrical power on voltage line 255 in response to operation of the second turbine 252. In an embodiment, the first and second generators 204, 254 are directly connected to the respective first and second turbines 202, 252 via respective rotatable shafts 212, 262.

In an embodiment, at least one of the first generator 204 and the second generator 254 have a permanent magnet rotor 210, 260, respectively. And in another embodiment, both the first generator 204 and the second generator 254 each have an electrically wired stator and a permanent magnet rotor 210, 260. In an embodiment, the first and second generators 204, 254 instead of having a permanent magnet rotor 210, 260, may have some other form of self-excited rotor, such as a self-excited rotor having a center winding and slip ring that creates a magnetic field from the slip ring, for example.

A first inverter 206 is operably connected to the first generator 204 to produce a first electrical power in response to a presence of the first AC electrical power. A second inverter 256 is operably connected to the second generator 254 to produce a second electrical power in response to a presence of the second AC electrical power. The eTurbine system 200 is configured such that the first and second electrical powers have different voltages on first and second voltage buses 208, 258, respectively. Example voltages on the first and second voltage buses 208, 258 may include but are not limited to 100VDC, 320VDC or 600VDC, for example, but other DC voltages suitable for a vehicular purpose are contemplated and considered to be within the scope of the invention disclosed herein.

In an embodiment, at least one of the first and second inverters 206, 256 is configured to produce AC electrical power output, such as 240VAC for servicing a refrigeration trailer load in an over-the-road truck, for example. Other AC voltages suitable for a vehicular purpose are contemplated and considered to be within the scope of the invention disclosed herein.

From the foregoing it will be appreciated that the first and second inverters 206, 256 may be configured in a variety of different ways, such as: to produce the first electrical power having a DC voltage, and the second electrical power having a DC voltage; to produce the first electrical power having a DC voltage, and the second electrical power having an AC voltage; or, to produce the first electrical power having an AC voltage, and the second electrical power having an AC voltage.

While voltage lines 205, 255, and voltage buses 208, 258, are depicted in FIG. 1 in single-line diagram form, it will be appreciated that the scope of the invention applies to single-phase, three-phase and poly-phase voltage systems. Any and all voltage systems suitable for a purpose disclosed herein are considered to be within the scope of the invention disclosed herein.

In an embodiment, and with reference still to FIG. 1, eCompressor system 300 includes a compressor 302 disposed in flow communication with the air intake system 104 of the CE 102, an electric motor 304 operably connected to the compressor 302, and a third inverter 306 operably connected to the electric motor 304, where the third inverter is a bi-directional inverter. As disclosed herein, it will be appreciated that an electric motor may be an asynchronous or a synchronous motor, such as an AC induction motor or a switched reluctance motor, respectively, as opposed to a (synchronous) permanent magnet motor. In an embodiment, the electric motor 304 has a permanent magnet rotor 310, and is directly connected to the compressor 302 via a rotatable shaft 312. The compressor 302, the electric motor 304 and the third inverter 306 have a first mode of operation, which in an embodiment is controlled by the VCM 400, to cause operation of the compressor 302 in response to the third inverter 306 being configured to provide an operational AC voltage to the electric motor 304, depicted by input line 308, and have a second mode of operation to cause the third inverter 306 to produce a third electrical power in response to operation of the compressor 302 driving the electric motor 304, depicted by output line 310 (also herein referred to as a third voltage bus). As used herein, it will be understood that operation of a compressor means rotation of an impeller within a housing of the compressor. The third electrical power has a voltage that is different from at least one of the voltages of the first electrical power and the second electrical power. In the first mode of operation, the electric motor 304 drives the compressor 302, via input command signals from the VCM 400, for boosting air intake in the CE 102 on demand. In the second mode of operation, the third inverter 306 is configured to provide the third electrical power with a DC voltage, such as 12VDC or 24VDC for example, or an AC voltage, such as 12VAC, 24VAC, 40VAC or 120VAC for example. As disclosed herein, it will be appreciated that power to the inverters 206, 256, 306 and the VCM 400 may be provided by any suitable power source, such as a battery, a generator, an ultracapacitor, or any other source of power employable with a vehicle operated by the CE 102.

As described above, the VCM 400 is operably connected to the eTurbine system 200 and the eCompressor system 300. More specifically, and for the respective embodiments disclosed herein, the VCM 400 is operably connected to the first inverter 206, the second inverter 256, and the third inverter 306, and is configured to facilitate distribution of the first electrical power on the first voltage bus 208, the second electrical power on the second voltage bus 258, and the third electrical power on the third voltage bus 310, and to facilitate switching between the first mode of operation and the second mode of operation of the eCompressor system 300 on demand.

Reference is now made to FIG. 2, which depicts an alternative eTurbine system 270 where the components depicted inside dashed lines 120 in FIG. 1 are replaced with those depicted inside dashed lines 130 in FIG. 2. Like elements are numbered alike. Unlike the eTurbine system 200, the eTurbine system 270 has a single turbine 202 disposed in flow communication with the exhaust manifold 114 that is in flow communication with the exhaust ports 112, and a single generator 204 that is operably connected to the single turbine 202 to produce AC electrical power in response to operation of the single turbine 202. Similar to the eTurbine system 200, the eTurbine system 270 has a first inverter 206 and a second inverter 256. However, unlike the eTurbine system 200, the first and second inverters 206, 256 of eTurbine system 270 are operably connected to the single generator 204 via a switch 272 that is operably disposed to connect the single generator 204 to the first inverter 206 when the switch 272 is in a first state (solid line as depicted in FIG. 2), and to connect the single generator 204 to the second inverter 256 when the switch 272 is in a second state (dashed line as depicted in FIG. 2). In response to operation of the single turbine 202, the single generator 204 produces AC electrical power, which is delivered to the switch 272. Operation of the switch 272 between the first and second states is controlled, in an embodiment, by the VCM 400 to divert power, via the first and second inverters 206, 256, to whatever vehicle system requires the power. Similar to the eTurbine system 200, the first and second inverters 206, 256 are configured to produce first and second electrical power having different voltages on first and second voltage buses 208, 258, respectively, for a purpose similar to that discussed above in connection with FIG. 1.

As discussed above, CE 102 may be any type or size of engine having any of a number of different cylinder (combustion chamber) arrangements. On certain types of engines, such as V-type engines, an eTurbine on each side of the engine may provide a different voltage level, such as 240VAC for a refrigeration system and 600VDC for a traction drive system, for example. Additionally, and depending on size of the engine an eTurbine may be mounted on just one or two cylinder(s) to provide 12VDC system power, and the remaining cylinders may be used to drive an eTurbine to power a traction drive system at a voltage of 100VDC or greater. As will be appreciated from the limited system configurations described herein, there exists numerous possibilities for a variety of different system configurations. Any and all such system configurations suitable for a purpose disclosed hererin are contemplated and considered to be within the scope of the invention disclosed herein.

From the foregoing, it will be appreciated that multiple eTurbines may be used on a power generating system to generate different voltage levels that can be used to run different subsystems on a vehicle via different voltage buses, such as 12VDC for vehicle accessories, lights, and control systems and 320VDC for traction systems, for example. And in another power generating system having multiple eTurbines, an AC/DC converter may be used in combination with an eTurbine to capture exhaust energy that can be used to feed electrical power into a voltage bus, in addition to having another eTurbine generate power for a control system on a different voltage bus. As such, it will be appreciated that the disclosed invention encompasses a variety of alternative eTurbine power generation and distribution systems that can operate at multiple voltages in one system that are too many to describe individually. Such alternative systems that fall within the ambit of the invention disclosed herein are all considered to be in accordance with an embodiment of the invention disclosed herein.

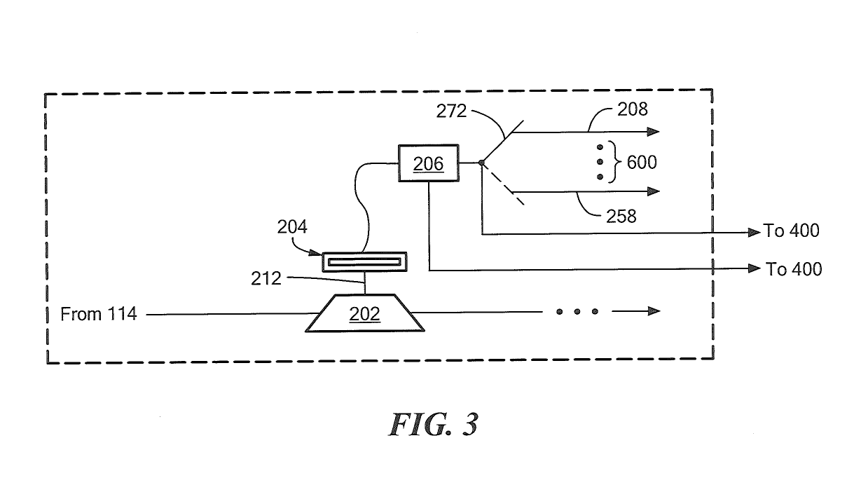

Reference is now made to FIG. 3, which depicts a single-turbine-generator-system that could be employed as an alternative to, or in combination with, either of the multiple-turbine-generator-system of FIG. 1, or the single-turbine-generator-system of FIG. 2. Here, a single inverter 206, electrically fed by a single generator 204 driven by a single turbine 202, is controlled by the VCM 400 to produce a plurality of different voltage levels on command that are electrically coupled to a switch 272 (having a first position shown in solid line, and a second position shown in dashed line), which is controlled by the VCM 400 to switch the different voltages onto different voltage buses 208, 258. While only two voltage buses 208, 258 are depicted, it will be appreciated that the plurality of different voltages can extend beyond two by using a multi-position switch 272, which is represented by ellipses 600. With such a single-turbine-generator-system as depicted in FIG. 3, system cost and space can be significantly reduced by using a single inverter 206 that feeds power to a switch 272.

From the foregoing, and while an embodiment is disclosed and described herein with reference to inverters, it will be appreciated that one or more of the inverters may be replaced with an AC/DC converter. For example, an embodiment of the invention may be applied using a common AC voltage bus on a vehicle. Here, AC power is be taken from the eTurbine-driven generator and placed on a 480VAC bus, or at any other desirable voltage for example. From this 480VAC bus, the AC voltage is stepped down to 18VAC, or to any other desirable voltage for example, using known methods such as a transformer. And from the 18VAC bus the AC voltage is rectified using an AC/DC converter to deliver 12VDC, or any other suitable voltage for example, for use by 12VDC systems of the vehicle. In another embodiment, the aforementioned exemplary 480VAC may be stepped down to 60VAC, and then an AC/DC converter is used to rectify the voltage down to 48VDC for use by 48VDC systems of the vehicle. Other embodiments may employ any other combination of AC and DC voltages as desired for use by vehicle systems.

While certain combinations of features relating to an automotive system have been described herein, it will be appreciated that these certain combinations are for illustration purposes only and that any combination of any of these features may be employed, explicitly or equivalently, either individually or in combination with any other of the features disclosed herein, in any combination, and all in accordance with an embodiment of the invention. Any and all such combinations are contemplated herein and are considered within the scope of the invention disclosed.

In an embodiment, the VCM 400 includes a microprocessor 410 which is configured to be responsive to executable machine instructions which when executed by the microprocessor 410 facilitates operation of the various components described herein for producing different operational voltages on different voltage buses as described herein.

As such, an embodiment of the invention may be embodied in the form of computer-implemented processes and apparatuses for practicing those processes. The present invention may also be embodied in the form of a computer program product having computer program code containing instructions embodied in tangible media, such as floppy diskettes, CD-ROMs, hard drives, USB (universal serial bus) drives, or any other computer readable storage medium, such as random access memory (RAM), read only memory (ROM), erasable programmable read only memory (EPROM), electrically erasable programmable read only memory (EEPROM), or flash memory, for example, wherein, when the computer program code is loaded into and executed by a computer, the computer becomes an apparatus for practicing the invention. The present invention may also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein when the computer program code is loaded into and executed by a computer, the computer becomes an apparatus for practicing the invention. When implemented on a general-purpose microprocessor, the computer program code segments configure the microprocessor to create specific logic circuits. A technical effect of the executable instructions is to produce different operational voltages on separate voltage buses in a single vehicle by operation of an eTurbine, an eCompressor, or one or more of both an eTurbine and an eCompressor.

While the invention has been described with reference to exemplary embodiments, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed, but that the invention will include all embodiments falling within the scope of the appended claims. Also, in the drawings and the description, there have been disclosed exemplary embodiments of the invention and, although specific terms may have been employed, they are unless otherwise stated used in a generic and descriptive sense only and not for purposes of limitation, the scope of the invention therefore not being so limited. Moreover, the use of the terms first, second, etc. do not denote any order or importance, but rather the terms first, second, etc. are used to distinguish one element from another. Furthermore, the use of the terms a, an, etc. do not denote a limitation of quantity, but rather denote the presence of at least one of the referenced item.

What is claimed is:

1. A system for providing multiple voltage buses on a single vehicle having a combustion engine, the system comprising:
at least one turbine disposed in flow communication with an exhaust flow of the combustion engine productive of exhaust gases;
at least one generator operably connected to a respective one of the at least one turbine to produce respective AC electrical power in response to operation of the at least one turbine;
a first inverter operably connected to the at least one generator to produce first electrical power in response to a presence of the respective AC electrical power; and
a second inverter operably connected to the at least one generator to produce second electrical power in response to a presence of the respective AC electrical power;
wherein the first electrical power and the second electrical power have different voltages.

2. The system of claim 1, wherein:
the at least one turbine comprises:
a first turbine disposed in flow communication with a first portion of an exhaust flow of the combustion engine productive of exhaust gases;
a second turbine disposed in flow communication with a second portion of the exhaust flow of the combustion engine, the second portion being different from the first portion; the at least one generator comprises:
a first generator operably connected to the first turbine to produce first AC electrical power in response to operation of the first turbine;
a second generator operably connected to the second turbine to produce second AC electrical power in response to operation of the second turbine;
the first inverter is operably connected to the first generator to produce the first electrical power in response to a presence of the first AC electrical power; and
the second inverter operably connected to the second generator to produce the second electrical power in response to a presence of the second AC electrical power.

3. The system of claim 1, wherein the at least one turbine is a single turbine, the at least one generator is a single generator, and further comprising:
a switch operably disposed to connect the single generator to the first inverter when the switch is in a first state, and to connect the single generator to the second inverter when the switch is in a second state.

4. The system of claim 1, further comprising:
a compressor disposed in flow communication with an air intake system of the combustion engine;
an electric motor operably connected to the compressor; and
a third inverter operably connected to the electric motor, wherein the third inverter is a bi-directional inverter;
wherein the compressor, the electric motor and the third inverter have a first mode of operation to cause operation of the compressor in response to the third inverter being configured to provide an operational AC voltage to the electric motor; and
wherein the compressor, the electric motor and the third inverter have a second mode of operation to cause the third inverter to produce a third electrical power in response to operation of the compressor driving the electric motor, the third electrical power having a voltage different from at least one of the voltages of the first electrical power and the second electrical power.

5. The system of claim 1, further comprising:
a vehicle control module operably connected to the first inverter and the second inverter, the vehicle control module configured to facilitate distribution of the first electrical power and the second electrical power.

6. The system of claim 4, further comprising:
a vehicle control module operably connected to the first inverter, the second inverter, and the third inverter, the vehicle control module configured to facilitate distribution of the first electrical power, the second electrical power, and the third electrical power, and to facilitate switching between the first mode of operation and the second mode of operation on demand.

7. The system of claim 1, wherein the first electrical power has a DC voltage, and the second electrical power has a DC voltage.

8. The system of claim 1, wherein the first electrical power has a DC voltage, and the second electrical power has an AC voltage.

9. The system of claim 1, wherein the first electrical power has an AC voltage, and the second electrical power has an AC voltage.

10. The system of claim 4, wherein the third electrical power has a DC voltage.

11. The system of claim 4, wherein the third electrical power has an AC voltage.

12. The system of claim 1, wherein the AC electrical power is single-phase AC electrical power.

13. The system of claim 1, wherein the AC electrical power is three-phase AC electrical power.

14. The system of claim 1, wherein at least one of the first inverter and the second inverter is a bi-directional inverter.

15. A system for providing multiple voltage buses on a single vehicle having a combustion engine, the system comprising:
a first turbine disposed in flow communication with a first portion of an exhaust flow of the combustion engine productive of exhaust gases;
a second turbine disposed in flow communication with a second portion of the exhaust flow of the combustion engine, the second portion being different from the first portion;
a first generator operably connected to the first turbine to produce first AC electrical power in response to operation of the first turbine;
a second generator operably connected to the second turbine to produce second AC electrical power in response to operation of the second turbine;
a first inverter operably connected to the first generator to produce first electrical power in response to a presence of the first AC electrical power; and
a second inverter operably connected to the second generator to produce second electrical power in response to a presence of the second AC electrical power;
wherein the first electrical power and the second electrical power have different voltages.

16. The system of claim 15, further comprising:
a compressor disposed in flow communication with an air intake system of the combustion engine;
an electric motor operably connected to the compressor; and
a third inverter operably connected to the electric motor, wherein the third inverter is a bi-directional inverter;
wherein the compressor, the electric motor and the third inverter have a first mode of operation to cause operation of the compressor in response to the third inverter being configured to provide an operational AC voltage to the electric motor; and
wherein the compressor, the electric motor and the third inverter have a second mode of operation to cause the third inverter to produce a third electrical power in response to operation of the compressor driving the electric motor, the third electrical power having a voltage different from at least one of the voltages of the first electrical power and the second electrical power.

17. The system of claim 15, wherein at least one of the first inverter and the second inverter is a bi-directional inverter.

18. A system for providing multiple voltage buses on a single vehicle having a combustion engine, the system comprising:
a turbine disposed in flow communication with an exhaust flow of the combustion engine productive of exhaust gases;
a generator operably connected to the turbine to produce AC electrical power in response to operation of the first turbine;
a first inverter operably connected to the generator to produce first electrical power in response to a presence of the AC electrical power;
a second inverter operably connected to the generator to produce second electrical power in response to a presence of the second AC electrical power; and
a switch operably disposed to connect the generator to the first inverter when the switch is in a first state, and to connect the generator to the second inverter when the switch is in a second state;
wherein the first electrical power and the second electrical power have different voltages.

19. The system of claim 18, wherein at least one of the first inverter and the second inverter is a bi-directional inverter.

20. A system for providing multiple voltage buses on a single vehicle having a combustion engine, the system comprising:
a turbine disposed in flow communication with an exhaust flow of the combustion engine productive of exhaust gases;
a generator operably connected to the turbine to produce AC electrical power in response to operation of the turbine;
an inverter operably connected to the generator to produce first electrical power at a first voltage and second electrical power at a second voltage in response to a presence of the AC electrical power, the second voltage being different from the first voltage; and
a switch operably disposed to connect the inverter to a first voltage bus when the switch is in a first state, and to connect the inverter to a second voltage bus when the switch is in a second state.
